(19) United States
(12) Patent Application Publication
(10) Pub. No.: US 2007/0043454 A1
(43) Pub. Date: Feb. 22, 2007

(54) Multi-function remote controller and programmer for landscape systems

(76) Inventor: John Sonnenberg, Carlsbad, CA (US)

Correspondence Address: Steven W. Webb;Law Offices of Steven W. Webb, 655 2nd Street, Encinitas, CA, 92024, US

(21) Appl. No.: 11/207,530

(22) Filed: Aug. 22, 2005

(51) Int. Cl. G05B 19/18

(52) U.S. Cl. 700/65; 700/66

(57) ABSTRACT

An improved landscape device controller system is presented where the controller is capable of remotely controlling multiple devices and multiple types of devices by means of a microprocessor-controlled hand-held device. The invention can be programmed to set various parameters in electrical timers, controllers, and landscape devices, such as time of day, duration of operation, start time and the like. The invention uses low-power radio communication, including receiving return signals from the device controllers and displaying their status on the controller. The invention is programmable to accommodate a multitude of devices and allow the user to control the devices while carrying the portable controller.

### BACKGROUND OF THE INVENTION

The typical residential or commercial landscape around a building has an irrigation controller to control the watering, a low-voltage lighting run off of a transformer connected to a timer, wide-area lights connected to a 110 VAC timer, and other subsystems, for example a water fountain having its own timer. The timers and controllers for these subsystems control when the devices are turned on or off by time of day, and other functions.

Some commercially-available timers and controllers possess remote-control options, but to date, all remote controls perform only simple on/off commands. These controllers are also technology specific, and a remote control for an irrigation timer cannot communicate to a low-voltage light. Landscape lighting timers are usually mechanically driven, and lose the correct time when the power is lost. When they lose their time, they must be manually reset.

Landscape irrigation controllers may have remote control options, but these cannot adjust internal controller parameters, such as water run times, the time of day clock, or the watering schedule. A hand-held remote control for an irrigation controller cannot control any other device that is not connected to the irrigation controller.

This invention solves these problems, buy combining the technologies required to control and to program irrigation, lighting, pumps, valves, and the like. The Multi-Function Remote Controller and Programmer for Landscape allows not only on/off commands to be sent remotely, but can also re-program the controllers and timers connected to its system, allowing schedules, time-clocks, and other parameters to be remotely set or modified.

### BRIEF SUMMARY OF THE INVENTION

Physically the invention's user interface is hand-held size, having a keypad on the front, and radio transmitter in it. It may also have a display, an LCD display in the preferred embodiment. It may also have a receiver in it, to receive signals from the external controllers. FIG. 2 shows one embodiment including a display.

The hand-held wireless remote control includes the following circuits:

Radio. A radio transceiver operating in one of the un-licensed frequency bands. It can transmit digital data to controllers and timers, and it can receive digital data from controllers and timers.

Keypad: Buttons provided on the front panel to facilitate user entry. The keypad could be as simple as two-button, or as sophisticated as a full keyboard. FIG. 2 illustrates a set of buttons that will make the device universally simple to use.

Microprocessor: The microprocessor controls the LCD display, scans the buttons for key presses, controls the radio transmitter and receiver. The Microprocessor possess a FLASH memory that is used to hold its firmware and settings, and RAM memory for variables, time and configuration information for it and the other subsystems. The microprocessor communicates with the various timers and controllers, using the radio and displaying controller and timer information using the LCD.

LCD display. An LCD display, in the preferred embodiment, is used to show various function and modes of the device. The device has a plurality of modes, depending upon the type of controller or timer it is communicating with. Icons or words shown on the display may be used to represent the mode.

Battery: For portability, the device is battery operated. The Hand Held Remote as described will communicate with a controller or timer. The controller or timer must have a radio receiver in it that is compatible with the remote above. If the remote is used for reading information back from a controller or timer, the controller or timer must also have a transmitter in it.

An alternative embodiment is a small “Key FOB” sized device, lacking a display and possessing a limited number of keypad buttons.

### OBJECTS OF THE INVENTION

It is an object of this invention to provide a new hand-held remote controller that can control multiple landscape subsystems.

It is a further object of this invention to provide such a controller with programmability to allow for expansion of controllers handled and additional functions.

It is a further object of this invention to provide the controller with an easily-read display system that uses iconography to represent the functions controlled.

Further objects of this invention can be discerned by perusing the detailed description, drawings, specifications and claims of this application.

### BRIEF DESCRIPTION OF THE DRAWINGS

The construction and operation of the invention can be readily appreciated from inspection of the drawings that accompany this application, combined with the detailed specification to follow.

FIG. 1 is an overview of a typical landscape system

FIG. 2 is a front view of a typical controller

FIG. 3 is a close-up view of the controller display

FIG. 4 is a block diagram of the circuits within the controller

### DETAILED DESCRIPTION OF THE INVENTION

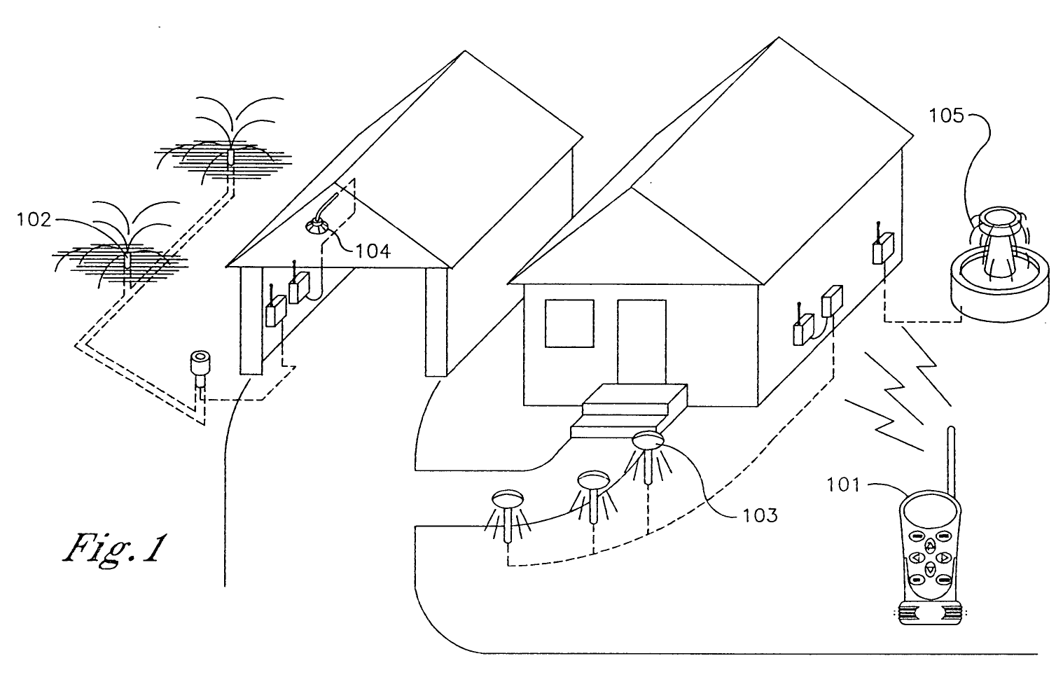

As shown in FIG. 1, the invention is a hand-held wireless remote control device 101 with the capability to remotely control multiple electrical control devices, including at least two of the following: irrigation controllers 102, AC light controllers 104, low-voltage light controllers 103, pump controllers 105, light timers 104, or electrical timers 105.

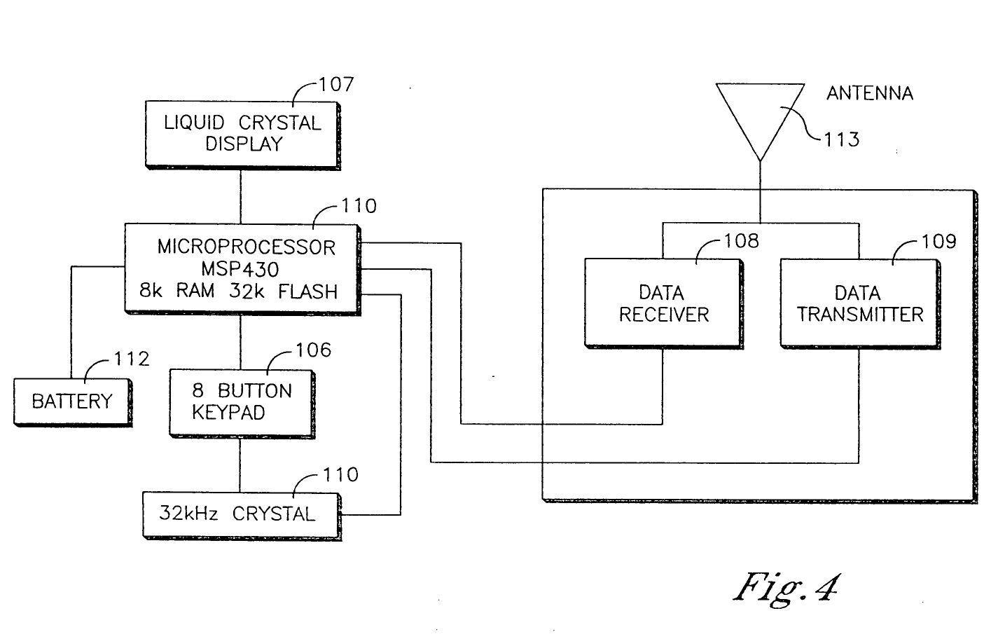

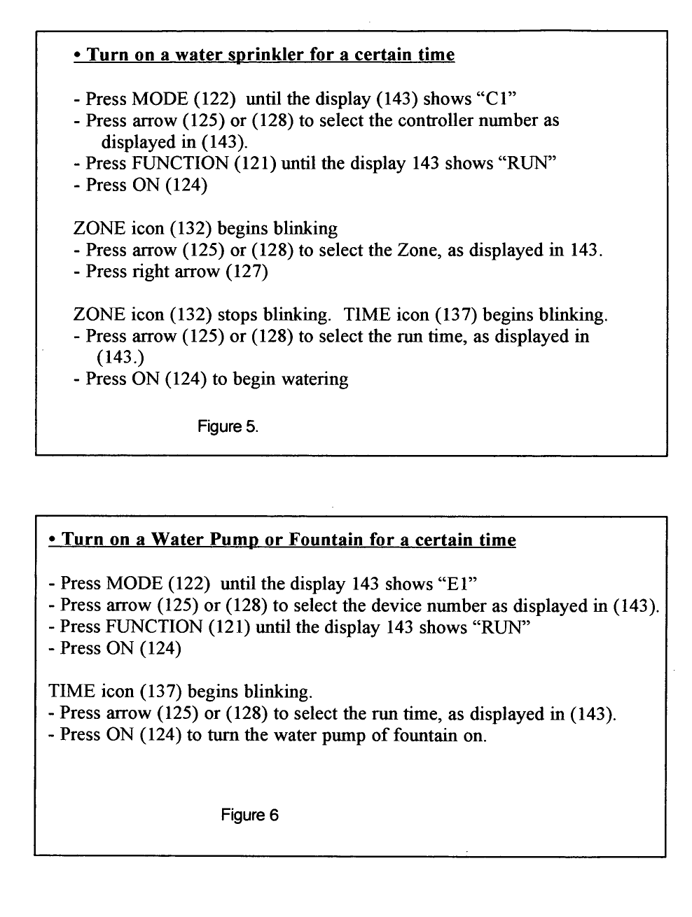

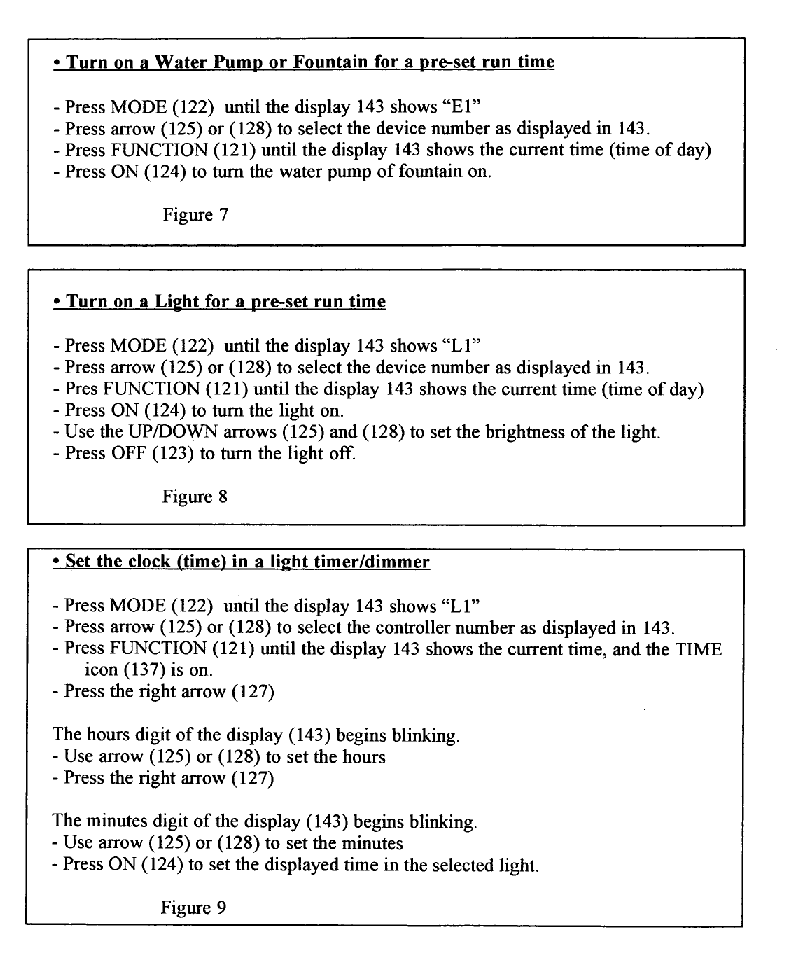

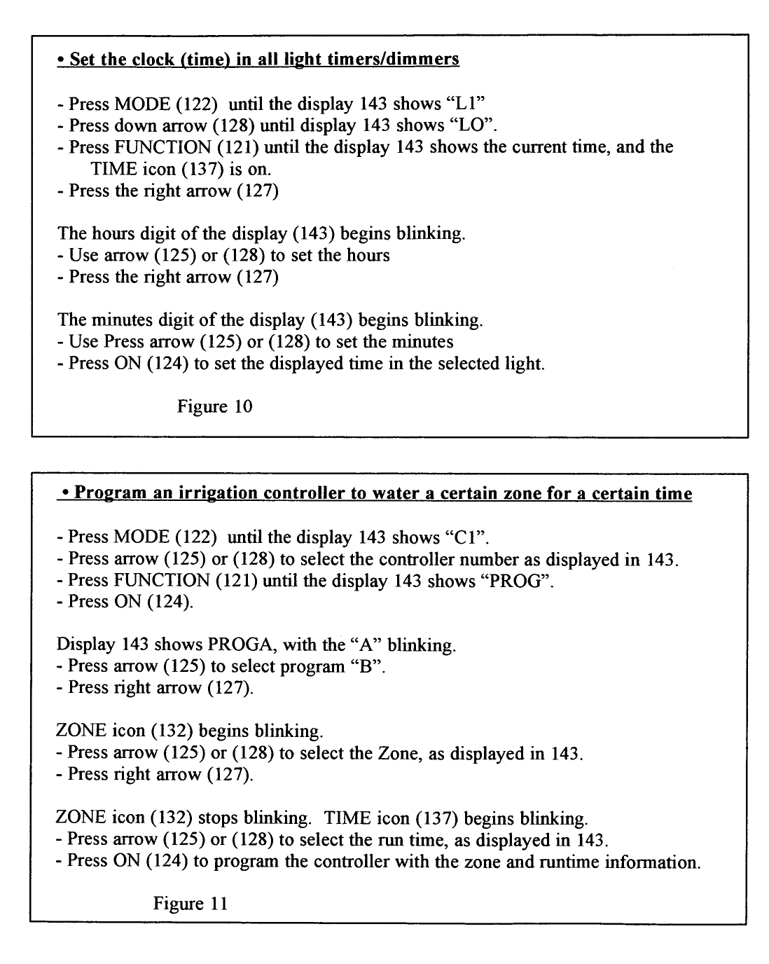

As in FIG. 4, The device block diagram includes the LCD display 107, a microprocessor 110, in the preferred embodiment an MSP430 with 8K of RAM and 32K of Flash memory, a battery 112 to power the system, and a data receiver/transmitter 108,109 to communicate with the landscape controllers.

The radio transceiver 108,109 operates in one of the un-licensed frequency bands. It can transmit digital signals to controllers and timers, and it can receive digital data from controllers and timers.

The microprocessor 110 controls the LCD display 107, scans the buttons 106 for key presses, controls the radio transmitter and receiver 108,109. The microprocessor 110 possess PROM/RAM memory that is minimally reprogrammable to add new subsystem controls.

In the preferred embodiment, the LCD display 107 is used to show various function and modes of the device. The device has a plurality of modes, depending upon the type of controller or timer it is communicating with. Icons or words shown on the display may be used to represent the mode.

The device is battery 112 operated. For portability.

The invention as described will communicate with a controller or timer attached to landscape equipment. The controller or timer must have a radio receiver in it that is compatible with the remote above. If the remote is used for reading information back from a controller or timer, the controller or timer must also have a transmitter in it.

An alternative embodiment is a small “Key FOB” sized device, lacking a display and possessing a limited number of keypad buttons.

Some variations to the preferred embodiments could include these changes: a) The radio could be a higher-powered radio operating on a licensed frequency in the VHF or UHF radio bands. b) For hand-held wireless remote control devices that only issue remote control commands, and do not receive data back from the device it is controlling, the radio could be a transmit-only device. c) The LCD display could utilize other display technologies such as LED displays or LED indicators.

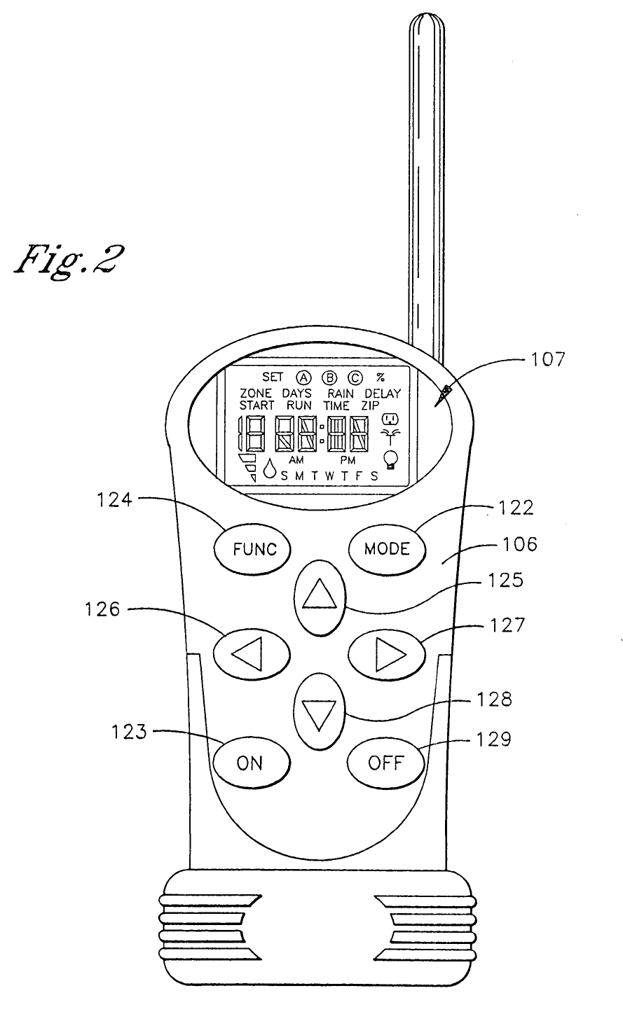

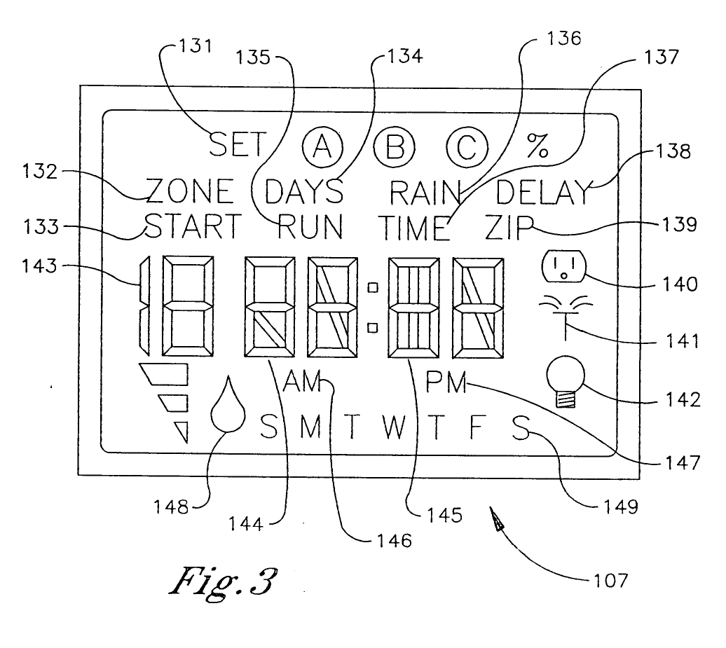

In FIG. 2, the keypad possesses a plurality of buttons, including Function 121, Mode 122, Escape 123, Enter 124, Up-Arrow 125, Left-Arrow 126, Right-Arrow 127, and Down-Arrow 128. FIG. 3 shows a close-up of the display, with the following indicator displays: Set Bar 131, Zone 132, Start 133, Days 134, Run 135, Rain 136, Time 137, Delay 138, Zip 139, Power 140, Sprinkler 141, Lights 142, Hours 143, Minutes 144, Seconds 145, AM 146, PM 147, Water 148, and Weekdays 149.

The invention has the ability to reprogram operational parameters in the devices it is controlling, via the keypad 106 and the display 107. The sequence of control program steps will depend on the devices controlled. Typical control step sequences would be as shown in FIG. 5, Turn on a water sprinkler for a certain time, or FIG. 6, Turn on a Water Pump or Fountain for a certain time.

The invention can also pre-set run times for delayed start and pre-set duration, as in FIG. 7, Turn on a Water Pump or Fountain for a pre-set run time or FIG. 8 Turn on a Light for a pre-set run time.

The invention has the ability to set the internal clock in one or more of the devices it can communicate with, as shown in the control steps in FIG. 9 Set the clock (time) in a light timer/dimmer.

The invention can reprogram parameters including “start time” and “on duration” in one or more of devices it can communicate with as shown in FIG. 10 Set the clock (time) in all light timers/dimmers.

The invention can also program a device to cover each of several zones at a certain time, as in FIG. 11 Program an irrigation controller to water a certain zone for a certain time.

The preferred embodiment of the invention includes the keyboard and display shown in FIG. 2, with the display implemented as an LED device.

While the foregoing describes a preferred embodiment and several alternative embodiments, variation on this design and equivalent designs may be resorted to in the scope and spirit of the claimed invention.

1. What is claimed is:a multi-function controller for remote control electrical devices, the controller comprised of a microprocessor system, a data entry system, a power supply, and a communication system,
the power supply a battery,
the communication system capable of communicating with a plurality of remote control electrical devices, the communication system able to send data transmissions to the remote control electrical devices such that the remote control electrical devices will set a plurality of internal control function parameters based on said data transmissions,
the data entry system comprised of a keypad and a data entry display, the keypad possessing a plurality of buttons, the buttons labelled with command icons or words, the data entry display comprised of a plurality of numbers, words, and icons that are indicators of the machine state of the multi-function controller and the machine state of the remote control electrical devices that multi-function controller is communicating with, the data entry display minimally capable of displaying time,
the multi-function controller operated by pressing a subset of the buttons on the keypad,
The multi-function controller capable of displaying the status and machine state of the multi-function controller and the machine state of the remote control electrical devices that the multi-function controller is communicating with by means of the data entry display.

2. The multi-function controller of claim 1 where the communications system is capable of receiving from as well as transmitting data to the remote control electrical devices, the communication system capable of passing on received signals from the remote control electrical devices to the microprocessor system, the microprocessor system capable of interpreting the signals, the display system capable of displaying the meaning of the received signals on the data entry display.

3. The multi-function controller of claim 1 where the communications system is capable of transmitting a single message that is receivable by multiple remote control electrical devices so as to configure a specific parameter or parameters within each remote control electrical device.

4. The multi-function controller of claim 1 where the communications system is capable of transmitting a “set time” message that is received by multiple remote control electrical devices, so as to set the real-time clocks in the multiple remote control electrical devices with one transmission.
